(19) United States
(12) Patent Application Publication
(10) Pub. No.: US 2023/0402765 A1
(43) Pub. Date: Dec. 14, 2023

(54) PATCH ANTENNA UNIT AND ANTENNA ARRAY IN PACKAGE

(71) Applicant: SPREADTRUM COMMUNICATIONS (SHANGHAI) CO., LTD., Shanghai (CN)

(72) Inventors: Kai KANG, Pudong New Area, Shanghai (CN); Shusheng GUO, Pudong New Area, Shanghai (CN); Hongyu TIAN, Pudong New Area, Shanghai (CN); Jikang HUANG, Pudong New Area, Shanghai (CN)

(21) Appl. No.: 18/033,217

(22) PCT Filed: May 8, 2021
(86) PCT No.: PCT/CN2021/092247

§ 371 Date: Apr. 21, 2023

(30) Foreign Application Priority Data
Oct. 22, 2020 (CN) 202011140354.8

(51) Int. Cl. H01Q 21/06; H01Q 9/04; H01Q 21/20

(52) U.S. Cl. CPC H01Q 21/065; H01Q 9/0414; H01Q 21/20

(57) ABSTRACT

A patch antenna unit and an antenna array in package are provided. The patch antenna unit includes: a substrate; and two groups of stacked patches which respectively stack on the substrate, geometric axes of the two groups of stacked patches being perpendicular to each other, wherein a radiating edge of each patch in the stacked patches is shaped as a function curve, the radiating edges of the patches in different layers are shaped as integrally orthogonal function curves, and a function curve corresponding to a shape of a non-radiating edge of each patch includes a ripple function curve.

### CROSS-REFERENCE TO RELATED APPLICATIONS

This is the U.S. national stage of application No. PCT/CN2021/092247, filed on May 8, 2021. Priority under 35 U.S.C. § 119(a) and 35 U.S.C. § 365(b) is claimed from Chinese Application No. 202011140354.8, filed Oct. 22, 2020, the disclosure of which is also incorporated herein by reference.

### TECHNICAL FIELD

The present disclosure generally relates to antenna technology field, and more particularly, to a patch antenna unit and an antenna array in package.

### BACKGROUND

5G standards of 3GPP define five millimeter-wave frequency bands N257 to N261 of NR-FR 2, including both 24.25 GHz to 29.5 GHz and 37 GHz to 43.5 GHz. Supporting the above frequency 5 bands N257 to N261 in a same Antenna in Package (AiP) module will facilitate various requirements in practical applications. 5G mobile intelligent terminals are becoming more and more complex in functional structures, and thinner in industrial design. Therefore, chip packaging should follow miniaturization and low cost design as much as possible.

By integrating various technical requirements of millimeter wave mobile communication, an AiP form integrating Transceiver Radio Frequency Integrated Circuit (TRX RFIC) and antenna array is most conducive to realizing functions and performance of highly integrated millimeter wave front-end single chip or module, thereby facilitating application of mobile terminals and various miniaturized devices. AiP realizes the antenna array and a feed network through a substrate in package, thus, a Microstrip Antenna (MSA) is generally used as an antenna unit. A relative bandwidth of a traditional MSA is relatively narrow, and the relative bandwidth of an ordinary single-layer MSA is smaller than 5%, which cannot meet requirements of covering full frequency bands. In addition, a system also requires implementing two orthogonal polarization modes, and maintaining high inter-polarization isolation to meet system requirements such as Multi Input Multi Output (MIMO). Existing stacked wideband dual polarization MSA technology is illustrated in FIG. 1, where at least 6 layers are required, including two layers of stack patch, two layers of dual polarization feed network wiring, one layer of slotted ground and one layer of reflector.

### SUMMARY

An embodiment of the present disclosure provides a patch antenna unit including: a substrate; and two groups of stacked patches which respectively stack on the substrate, geometric axes of the two groups of stacked patches being perpendicular to each other, wherein a radiating edge of each patch in the stacked patches is shaped as a function curve, the radiating edges of the patches in different layers are shaped as integrally orthogonal function curves, and a function curve corresponding to a shape of a non-radiating edge of each patch includes a ripple function curve.

An embodiment of the present disclosure also provides an antenna array in package, including a plurality of the patch antenna units described above.

### BRIEF DESCRIPTION OF THE DRAWINGS

FIG. 1 is a structural diagram of a stacked dual-polarized patch antenna unit in prior art;

FIG. 2 is a structural diagram of a patch antenna unit according to an embodiment;

FIG. 3 illustrates an impedance circle diagram of wideband impedance characteristics of the patch antenna unit shown in FIG. 2;

FIG. 4 illustrates a return loss of wideband impedance characteristics of the patch antenna unit shown in FIG. 2;

FIG. 5 illustrates inter-polarization isolation of the patch antenna unit shown in FIG. 2;

FIG. 6 illustrates an antenna gain of the patch antenna unit shown in FIG. 2;

FIG. 7 is a structural diagram of a patch antenna array according to an embodiment; and

FIG. 8 is a structural diagram of another patch antenna array according to an embodiment.

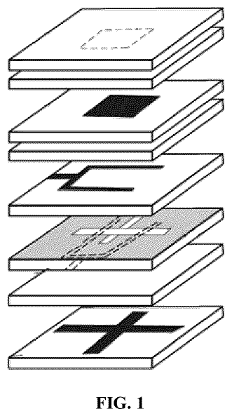

### DETAILED DESCRIPTION

An embodiment of the present disclosure provides a patch antenna unit including: a substrate; and two groups of stacked patches which respectively stack on the substrate, geometric axes of the two groups of stacked patches being perpendicular to each other, wherein a radiating edge of each patch in the stacked patches is shaped as a function curve, the radiating edges of the patches in different layers are shaped as integrally orthogonal function curves, and a function curve corresponding to a shape of a non-radiating edge of each patch includes a ripple function curve. In the patch antenna unit, two groups of stacked patches are disposed in such a way that the geometric axes are perpendicular to each other, so as to implement two mutually orthogonal polarization directions to accomplish dual-polarization work. Additionally, the radiating edges of the patches are shaped as function curves, and the radiating edges in different layers are shaped as integrally orthogonal function curves, thereby generating a plurality of resonance modes, and increasing a work bandwidth. The non-radiating edges of the patches have a shape corresponding to a ripple function curve, thereby forming a slow wave transmission structure, so as to reduce an area of the patches. Under conventional substrate packaging processes, the structure of the patch antenna unit provided in the embodiments of the present disclosure may achieve performance indicators such as good impedance matching, high antenna gain, and high polarization isolation, thereby meeting technical requirements of AiP wideband units. Due to the usage of mutually independent polarization units and frequency band units, inter-polarization and inter-frequency band isolation may be better guaranteed.

In order to make the above objectives, features, and advantages of the disclosure more apparent and understandable, specific embodiments of the disclosure are described in detail below in conjunction with the accompanying drawings.

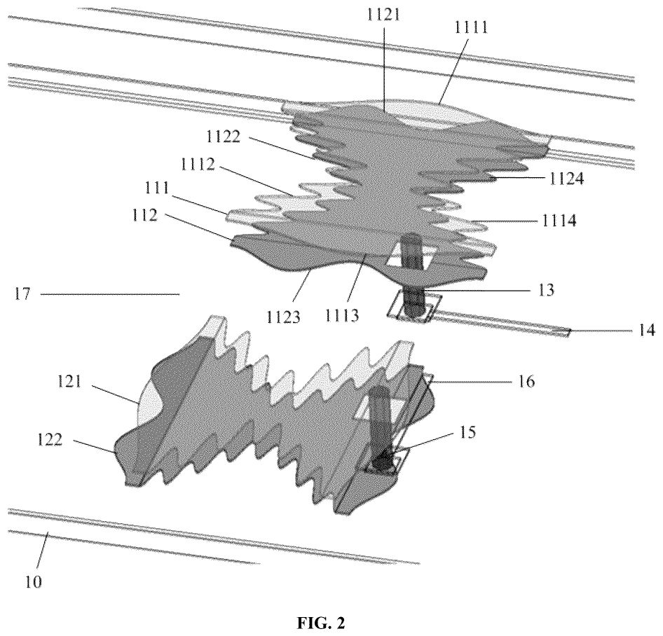

Referring to FIG. 2, FIG. 2 is a structural diagram of the patch antenna unit according to an embodiment.

In the embodiment, the patch antenna unit includes: a substrate 10; and two groups of stacked patches which respectively stack on the substrate 10, where one group of stacked patches includes a patch 111 and a patch 112, and the other group of stacked patches includes a patch 121 and a patch 122.

In some embodiments, each group of stacked patches may include more than two patches.

In some embodiments, the substrate 10 is a dielectric substrate or a printed circuit board.

As shown in FIG. 2, geometric axes of the two groups of stacked patches being perpendicular to each other. Such configuration achieves two mutually orthogonal polarization directions to accomplish dual-polarization work, namely, Vertical polarization and Horizontal polarization (V/H polarization). In some embodiments, a distance between the two groups of stacked patches is adjustable, and no limit is imposed on the specific value.

Still referring to FIG. 2, the patch 111 includes two radiating edges 1111 and 1113, and two non-radiating edges 1112 and 1114, and the patch 112 includes two radiating edges 1121 and 1123, and two non-radiating edges 1122 and 1124. Similarly, the patches 121 and 122 also respectively include two radiating edges and two non-radiating edges.

In some embodiments, the radiating edge of each patch in the stacked patches is shaped as a function curve. Specifically, the function curve is a triangular function curve, a parabolic function curve, a hyperbolic function curve, or an elliptic function curve, with a number of cycles being 1 or 2. That is, a shape of the radiating edge is a shape of a function curve with a small number of cycles.

In some embodiments, in each group of stacked patches, the radiating edges of the patches in different layers are shaped as integrally orthogonal function curves, which allows generating decoupling of a stacked-layer resonator coupling mode to support independent modes resonating at different frequencies, thereby widening an operating bandwidth.

In some embodiments, in each group of stacked patches, a function curve corresponding to a shape of the radiating edge of the patch in one of the two layers is:

y=A₁ cos(n·2π·x/W),

wherein W is a straight line distance from one end of the radiating edge of the patch to the other end of the radiating edge of the patch, A₁ is an amplitude of extension of the function curve, and n is a number of cycles that the function curve varies with the radiating edge of the patch.

Accordingly, in the group of stacked patches, a function curve corresponding to the radiating edge of the patch in the other of the two layers is:

y=A₂ cos(n′·2π·x/W),

wherein W is a straight line distance from one end of the radiating edge of the patch to the other end of the radiating edge of the patch, A₂ is an amplitude of extension of the function curve, and n′ is a number of cycles that the function curve varies with the radiating edge of the patch.

In some embodiments, n is 1 or 2, and accordingly n′ is 2 or 1, i.e., shapes of all the radiating edges are shapes of function curves with a small number of cycles.

In some embodiments, a function curve corresponding to a shape of a non-radiating edge of each patch includes a ripple function curve. Specifically, the ripple function curve is a triangular function curve, a parabolic function curve, a hyperbolic function curve, or an elliptic function curve, with a number of cycles being an integer greater than 3. In practical applications, considering feasibility of processes, the number of cycles of the ripple function curve may be any integer between 4 and 8. By configuring the non-radiating edges of the patches to have a shape of a ripple function, a slow wave transmission structure is formed, thereby reducing an area of the patches.

In some embodiments, the ripple function curve is:

y=A₀ cos(n·2π·x/L),

wherein L is a straight line distance from one end of the non-radiating edge of the patch to the other end of the non-radiating edge of the patch, A₀ is an amplitude of extension of the ripple function curve, n is a number of cycles that the ripple function curve varies with the non-radiating edge of the patch, and n is greater than 3.

In some embodiments, the function curve corresponding to the shape of the non-radiating edge of each patch is a superposition of the ripple function curve and a concave function curve, and the concave function curve is a triangular function curve, a parabolic function curve, a hyperbolic function curve or an elliptic function curve, with a number of cycles being 1 or 2, i.e., a concave function with a small number of cycles. By superposing a concave function with a small number of cycles on the basis of the slow wave structure, an area of the patch is reduced, and a distance between two groups of polarization units is increased.

In some embodiments, the concave function curve is:

y=A₁ cos(n′·2π·x/L),

wherein L is a straight line distance from one end of the non-radiating edge of the patch to the other end of the non-radiating edge of the patch, A₁ is an amplitude of extension of the concave function curve, n′ is a number of cycles that the concave function curve varies with the non-radiating edge of the patch, and n′ is 1 or 2.

Accordingly, the function curve corresponding to the shape of the non-radiating edge of each patch may be a superposition of the ripple function curve and a concave function curve, namely:

y=A₀ cos(n·2π·x/L)+A₁,

As shown in FIG. 2, the radiating edges 1111, 1113, 1121 and 1123 are relatively smooth because their shapes correspond to function curves with a small number of cycles, while the non-radiating edges 1112, 1114, 1122 and 1124 have concave ripple shapes, due to a superposition of function curves with a large number of cycles and concave function curves.

In the prior art, it is generally to increase impedance bandwidth of antennas by thickening a substrate. However, a thick substrate in a millimeter wave frequency band may bring significant surface wave losses. In order to avoid this problem and meet various requirements for chip packaging in AiP, in embodiments of the present disclosure, a thickness of the substrate 10 and a wavelength corresponding to an operating frequency of the patch antenna unit satisfy a following relationship:

h/λ₀<1/10,

wherein h is the thickness of the substrate 10, and λ₀ is the wavelength corresponding to the operating frequency of the patch antenna unit.

Still referring to FIG. 2, FIG. 2 also illustrates a first metal via 13, a first feeder 14, a second metal via 15, a second feeder 16, and a ground plane 17.

The ground plane 17 is disposed between the patch antenna and Radio Frequency Integrated Circuits (RFIC, not shown in FIG. 2, which is disposed at the back of the ground plane 17, i.e., a lowest part of the package). The ground plane 17, as a global ground for an antenna module in package, functions as a ground reflecting surface, which isolates parasitic radiation from the feeders, reduces impact on array beams, and isolates coupling interference between the antenna and the RFIC. An I/O port of the RFIC is connected to and excites the first group of patches 111 and 112 by the first feeder 14 which passes through the first metal via 13 of the ground plane 17, and is also connected to and excites the second group of patches 121 and 122 by the second feeder 16 which passes through the second metal via 15 of the ground plane 17.

In some embodiments, the RFIC may be set at any position on the substrate, such as a center of the substrate, or at some other location relative to the center of the substrate, which is not limited in embodiments of the present disclosure.

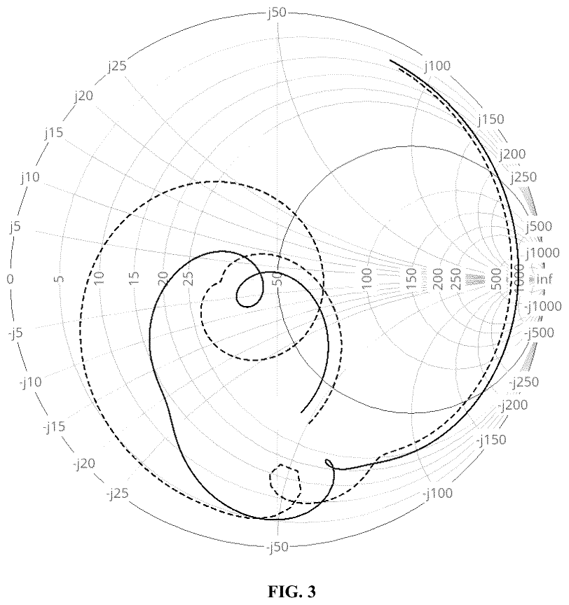

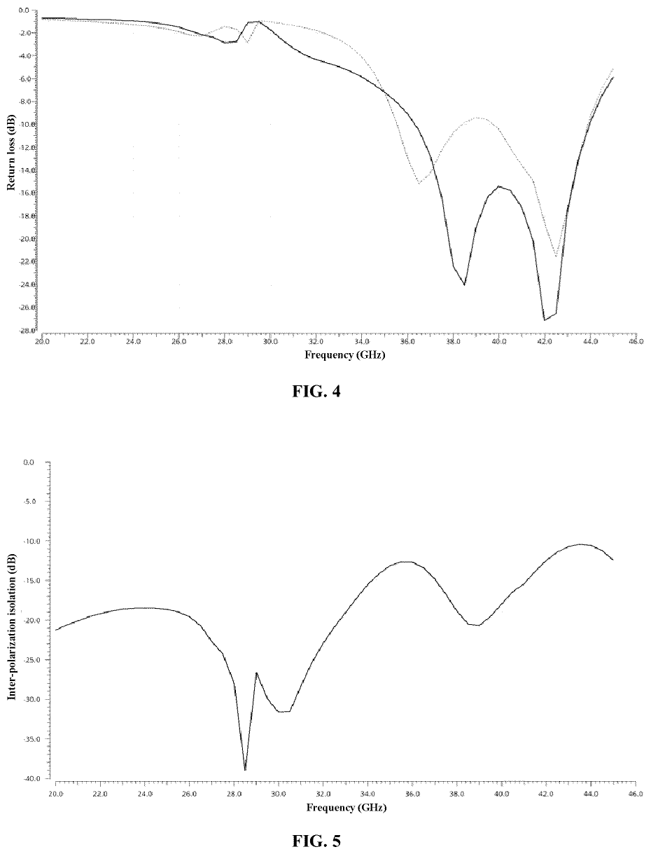

Referring to FIG. 3 and FIG. 4, FIG. 3 illustrates an impedance circle diagram of wideband impedance characteristics of the patch antenna unit shown in FIG. 2, and FIG. 4 illustrates a return loss of wideband impedance characteristics of the patch antenna unit shown in FIG. 2.

Specifically, FIG. 3 and FIG. 4 illustrate wideband impedance characteristics of the patch antenna unit in polarization directions respectively corresponding to the first metal via 13 and the second metal via 15. A solid line and a dotted line represent the two polarization directions, where the solid line represents a horizontal polarization impedance, and the dotted line represents a vertical polarization impedance. Horizontal ordinates in FIG. 4 are operating frequencies of the patch antenna unit, and vertical ordinates are the return losses. Specifically, in a frequency band from 35 GHz to 43.5 GHz, compared to prior art, the patch antenna unit provided by the embodiments of the present disclosure has better wideband impedance characteristics as capable to cover frequency bands N259 to N260.

Referring to FIG. 5, FIG. 5 illustrates inter-polarization isolation of the patch antenna unit shown in FIG. 2. Horizontal ordinates are operating frequencies of the patch antenna unit, and vertical ordinates are inter-polarization isolation. From experimental results, the antenna unit provided by the embodiments of the present disclosure has relatively high inter-polarization isolation.

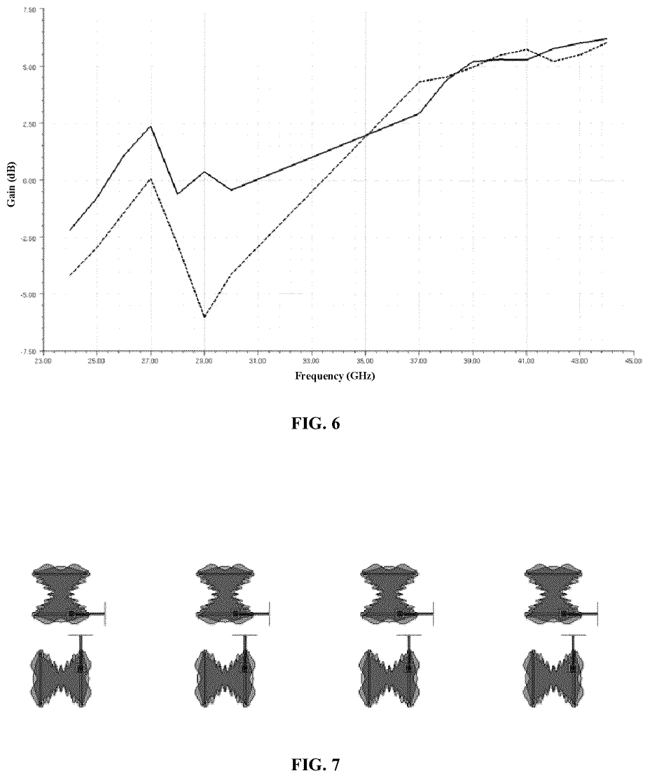

Referring to FIG. 6, FIG. 6 illustrates an antenna gain of the patch antenna unit shown in FIG. 2.

Specifically, FIG. 6 illustrates gain characteristics of the patch antenna unit in polarization directions corresponding to the first metal via 13 and the second metal via 15. Horizontal ordinates in FIG. 6 are operating frequencies of the patch antenna unit, and vertical ordinates are antenna gains. Specifically, in higher frequency bands, compared to prior art, the patch antenna unit provided by the embodiments of the present disclosure has better gain characteristics, and achieves a gain of about 6 dB with consideration of various losses.

Therefore, the patch antenna unit provided by the embodiments of the present disclosure possesses good wideband impedance and gain characteristics as well as high inter-polarization isolation in high frequency bands, thereby increasing operating bandwidth to satisfy communication requirements of user terminals in the high frequency bands (including frequency bands from N259 to N260).

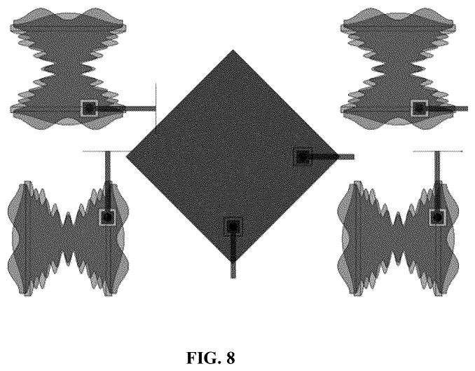

Referring to FIG. 7, FIG. 7 is a structural diagram of a patch antenna array according to an embodiment. The patch antenna array includes a plurality of patch antenna units. Specifically, each patch antenna unit may include two groups of stacked patches as shown in FIG. 2.

Referring to FIG. 8, FIG. 8 is a structural diagram of another patch antenna array according to an embodiment. The patch antenna array includes a plurality of groups of patch antenna units, each group of patch antenna units including two patch antenna units (high-frequency antenna units) as shown in FIG. 2 and one low-frequency antenna unit, thereby forming an AiP array covering full frequency bands of NR-FR2. FIG. 8 illustrates a complete group of patch antenna units and high-frequency antenna units in another group of patch antenna units. According to actual requirements, the patch antenna array may include two or more groups of the patch antenna units.

In summary, in the patch antenna unit provided by the embodiments of the present disclosure, two groups of stacked patches are disposed in such a way that the geometric axes are perpendicular to each other, so as to implement two mutually orthogonal polarization directions to accomplish dual-polarization work. Additionally, the radiating edges of the patches are shaped as function curves, and the radiating edges in different layers are shaped as integrally orthogonal function curves, thereby generating a plurality of resonance modes, and increasing a work bandwidth. The non-radiating edges of the patches have a shape corresponding to a ripple function curve, thereby forming a slow wave transmission structure, so as to reduce an area of the patches. Under conventional substrate packaging processes, the structure of the patch antenna unit provided in the embodiments of the present disclosure may achieve performance indicators such as good impedance matching, high antenna gain, and high polarization isolation, thereby meeting technical requirements of AiP wideband units. Due to the usage of mutually independent polarization units and frequency band units, inter-polarization and inter-frequency band isolation may be better guaranteed.

Further, the non-radiating edges of the patches have a ripple shape by using a function with a large number of cycles, which leads to slow wave effect in a transmission of electromagnetic waves along the patches to reduce a transmission distance.

Further, a function with a small number of cycles may be superimposed on the function with the large number of cycles to generate an inward concave of the non-radiating edges of the latches, thereby further reducing the area, and increasing a distance between two polarization units to improve the polarization isolation.

Accordingly, the patch antenna units provided by the embodiments of the present disclosure are prone to form a full-band antenna array in package with at least one low-frequency antenna unit to cover a full frequency band of NR-FR2.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A patch antenna unit, comprising:
a substrate; and
two groups of stacked patches which respectively stack on the substrate, geometric axes of the two groups of stacked patches being perpendicular to each other;
wherein a radiating edge of each patch in the stacked patches is shaped as a function curve, the radiating edges of the patches in different layers are shaped as integrally orthogonal function curves, and a function curve corresponding to a shape of a non-radiating edge of each patch comprises a ripple function curve.

2. The patch antenna unit according to claim 1, wherein the function curve is a triangular function curve, a parabolic function curve, a hyperbolic function curve, or an elliptic function curve.

3. The patch antenna unit according to claim 2, wherein each of the two groups of stacked patches comprises two patches in two layers, and a function curve corresponding to a shape of the radiating edge of the patch in one of the two layers is:
y=A₁ cos(n·2π·x/W),
wherein W is a straight line distance from one end of the radiating edge of the patch to the other end of the radiating edge of the patch, A₁ is an amplitude of extension of the function curve, and n is a number of cycles that the function curve varies with the radiating edge of the patch.

4. The patch antenna unit according to claim 3, wherein a function curve corresponding to the radiating edge of the patch in the other of the two layers is:
y=A₂ cos(n′·2π·x/W),
wherein W is a straight line distance from one end of the radiating edge of the patch to the other end of the radiating edge of the patch, A₂ is an amplitude of extension of the function curve, and n′ is a number of cycles that the function curve varies with the radiating edge of the patch.

5. The patch antenna unit according to claim 4, wherein n is 1 or 2, and accordingly n′ is 2 or 1.

6. The patch antenna unit according to claim 1, wherein the ripple function curve is a triangular function curve, a parabolic function curve, a hyperbolic function curve, or an elliptic function curve, with a number of cycles being an integer greater than 3.

7. The patch antenna unit according to claim 6, wherein the function curve corresponding to the shape of the non-radiating edge of each patch is a superposition of the ripple function curve and a concave function curve, and the concave function curve is a triangular function curve, a parabolic function curve, a hyperbolic function curve or an elliptic function curve, with a number of cycles being 1 or 2.

8. The patch antenna unit according to claim 7, wherein the ripple function curve is:
y=A₀ cos(n·2π·x/L),
wherein L is a straight line distance from one end of the non-radiating edge of the patch to the other end of the non-radiating edge of the patch, A₀ is an amplitude of extension of the ripple function curve, n is a number of cycles that the ripple function curve varies with the non-radiating edge of the patch, and n is greater than 3.

9. The patch antenna unit according to claim 8, wherein the concave function curve is:
y=A₁ cos(n′·2π·x/L),
wherein L is a straight line distance from one end of the non-radiating edge of the patch to the other end of the non-radiating edge of the patch, A₁ is an amplitude of extension of the concave function curve, n is a number of cycles that the concave function curve varies with the non-radiating edge of the patch, and n′ is 1 or 2.

10. The patch antenna unit according to claim 1, wherein a thickness of the substrate and a wavelength corresponding to an operating frequency of the patch antenna unit satisfy a following relationship:
h/λ₀<1/10,
wherein h is the thickness of the substrate, and λ₀ is the wavelength corresponding to the operating frequency of the patch antenna unit.

11. An antenna array in package, comprising a plurality of patch antenna units, wherein each of the plurality of patch antenna units comprises:
a substrate; and
two groups of stacked patches which respectively stack on the substrate, geometric axes of the two groups of stacked patches being perpendicular to each other;
wherein a radiating edge of each patch in the stacked patches is shaped as a function curve, the radiating edges of the patches in different layers are shaped as integrally orthogonal function curves, and a function curve corresponding to a shape of a non-radiating edge of each patch comprises a ripple function curve.

12. The antenna array in package according to claim 11, further comprising one or more low frequency antenna units.

13. The antenna array in package according to claim 11, wherein the function curve is a triangular function curve, a parabolic function curve, a hyperbolic function curve, or an elliptic function curve.

14. The antenna array in package according to claim 13, wherein each of the two groups of stacked patches comprises two patches in two layers, and a function curve corresponding to a shape of the radiating edge of the patch in one of the two layers is:
y=A₁ cos(n·2π·x/W),
wherein W is a straight line distance from one end of the radiating edge of the patch to the other end of the radiating edge of the patch, A₁ is an amplitude of extension of the function curve, and n is a number of cycles that the function curve varies with the radiating edge of the patch.

15. The antenna array in package according to claim 14, wherein a function curve corresponding to the radiating edge of the patch in the other of the two layers is:
y=A₂ cos(n′·2π·x/W),
wherein W is a straight line distance from one end of the radiating edge of the patch to the other end of the radiating edge of the patch, A₂ is an amplitude of extension of the function curve, and n′ is a number of cycles that the function curve varies with the radiating edge of the patch.

16. The antenna array in package according to claim 15, wherein n is 1 or 2, and accordingly n′ is 2 or 1.

17. The antenna array in package according to claim 11, wherein the ripple function curve is a triangular function curve, a parabolic function curve, a hyperbolic function curve, or an elliptic function curve, with a number of cycles being an integer greater than 3.

18. The antenna array in package according to claim 17, wherein the function curve corresponding to the shape of the non-radiating edge of each patch is a superposition of the ripple function curve and a concave function curve, and the concave function curve is a triangular function curve, a parabolic function curve, a hyperbolic function curve or an elliptic function curve, with a number of cycles being 1 or 2.

19. The antenna array in package according to claim 18, wherein the ripple function curve is:
y=A₀ cos(n·2π·x/L),
wherein L is a straight line distance from one end of the non-radiating edge of the patch to the other end of the non-radiating edge of the patch, A₀ is an amplitude of extension of the ripple function curve, n is a number of cycles that the ripple function curve varies with the non-radiating edge of the patch, and n is greater than 3.

20. The antenna array in package according to claim 19, wherein the concave function curve is:
y=A₁ cos(n′·2π·x/L),
wherein L is a straight line distance from one end of the non-radiating edge of the patch to the other end of the non-radiating edge of the patch, A₁ is an amplitude of extension of the concave function curve, n is a number of cycles that the concave function curve varies with the non-radiating edge of the patch, and n′ is 1 or 2.
